(19) United States
(12) Patent Application Publication
(10) Pub. No.: US 2025/0094163 A1
(43) Pub. Date: Mar. 20, 2025

(54) INCREMENTAL SOFTWARE DEVELOPMENT BASED ON BLUEPRINTS

(71) Applicant: SAP SE, Walldorf (DE)

(72) Inventor: Wolfgang Lindner, Walldorf (DE)

(21) Appl. No.: 18/467,165

(22) Filed: Sep. 14, 2023

(51) Int. Cl. G06F 8/658; G06F 8/41; G06F 8/71; G06F 11/36

(52) U.S. Cl. CPC G06F 8/658; G06F 8/433; G06F 8/71; G06F 11/3612

(57) ABSTRACT

The example embodiments are directed to systems and methods which can ship a viable software product to a customer in a very short amount of time and follow up the initially shipment with a more robust version of the software at a later time. In one example, a method may include storing multiple blueprints of a software application, wherein each blueprint comprises different code dependencies between code modules of the software application, receiving a request to run the software application from a computing device, identifying a most-recent blueprint, from among the multiple blueprints, which has fulfilled one or more prerequisites, and executing one or more code modules of the software application at the computing device based on dependencies between the one or more code modules included in the identified most-recent blueprint.

### BACKGROUND

To fully develop a software application from start to finish can take a developer (or a team of developers) months and even years of time. During the development process, the organization/owner of the software application cannot use the software. For businesses that use software for sales and other business-related activities, the slower the development of the software application the greater the likelihood of lost sales, lost efficiency, and lost opportunities. As such, the demand to ship software as fast as possible is always present.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIGS. 1A-1B are diagrams illustrating a host platform that delivers a software application in incremental phases in accordance with example embodiments.

FIG. 2A is a diagram illustrating a process of executing a software application based on an existing blueprint in accordance with an example embodiment.

FIG. 2B is a diagram illustrating a process of determining whether prerequisites are fulfilled in accordance with an example embodiment.

FIG. 2C is a diagram illustrating a process of executing a software application based on a fallback blueprint in accordance with an example embodiment.

FIG. 2D is a diagram illustrating a process of executing a software application based on a newly-generated blueprint in accordance with an example embodiment.

FIG. 3 is a diagram illustrating communication sequences for executing a software application based on blueprints in accordance with example embodiments.

FIG. 4 is a diagram illustrating a method of executing a software application based on a blueprint in accordance with an example embodiment.

FIG. 5 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

The example embodiments are directed to a host system that can be used to develop a software application incrementally thereby enabling a lightweight version of the software application to be shipped to a consuming system prior to a fully developed version of the software application. The host system in the example embodiments is the development system from where the software application is shipped to the consumer (e.g., a consuming system such as a web server, cloud platform, etc.). The shipped software application may include additional software (e.g., a blueprint factory, etc.) such as a cloud application that is delivered with the shipped software to the consuming system. Once shipped to the consuming system, the consuming system may run the software application and manage execution of the software application using the blueprints and the code module shipped to the consuming system. In particular, the blueprints define the building blocks/bricks (i.e., code units) that are used to build the software application and the dependencies between the code units during execution. To run the software application, the consuming system 120 may read a most-recent blueprint from the blueprints previously delivered and identify which code modules to launch based on the instructions within the blueprint.

According to various embodiments, a blueprint is a hardcoded set of instructions which identify the code modules that are included in a particular version of the software application. Each blueprint may be specific to a different version of the software application. For example, multiple versions of the software application may be defined using multiple versions of a blueprint of the software application, respectively. Each blueprint may be a computer-readable file or other medium with hardcoded instructions therein. The blueprint factory and the blueprint versions that are available at that time may be delivered/shipped to the consuming system with the version of the software.

In the example embodiments, the consuming system is the “runtime” system where the software application is executed and where the blueprints are read/queried by the consuming system. For example, during execution, the consuming system may analyze a blueprint or multiple version of a blueprint and also identify the prerequisites which have been fulfilled and which have not been fulfilled from the blueprints previously shipped from the host platform. This enables the consuming system to identify a most-recent version of the software application that is fully ready for execution (all prerequisites fulfilled). Furthermore, the consuming system may read and identify the code modules needed for executing a particular version of the software application and the dependencies among the code modules when they are executed. The consuming system can query this information and build an instance of the software application that is then executed on the consuming device.

In some embodiments, the software application may be delivered in phases. As an example, an initial version of the software shipped to the consuming system may provide a lightweight version of the software application. For example, the initial lightweight version of the software application may include basic functionality, user permissions, etc. After the initial version is shipped, additional development on the software application may occur (e.g., at the host platform) and additional features may be added to the software application. As a result, a second version of the software application with more/better features may be shipped to the consuming system. In this example, the second version includes a second blueprint. The consuming system will then have two blueprints for two different versions of the same software application. The consuming system can decide which version to execute based on which blueprint is most recent. Furthermore, before executing the most-recent blueprint, the consuming system can verify that any prerequisites of the most-recent blueprint have been fulfilled. The prerequisites may be listed inside the blueprint and can be verified by simply querying the blueprint. If a prerequisite is missing (i.e., not fulfilled yet), the consuming system can fallback to a later version of the software application where all the prerequisites have been fulfilled.

Some of the benefits of the example embodiments is that it enables incremental software development to be performed on a rolling basis (over time). An initial version of a software application, such as a software application that performs a basic, minimum functionality desired by the consumer, can be shipped prior to a full version of the software application being shipped thereby enabling the consumer to start using their software in a much shorter period of time than waiting for the fully developed software application.

For example, a first version (basic application) may be shipped quickly and a more robust version (full application) may be shipped at a later time. Both shipments may be sent to a consuming system such as a web server. In addition, the shipments may include blueprints for executing the versions of the software application. The blueprints are encoded with requirements (also referred to herein as prerequisites) needed to execute each version of the software application. Furthermore, the complete software application including the code modules needed for executing the software application may be delivered to the consuming system with the shipments. Accordingly, the consuming system can find the most-recent blueprint (newest blueprint) with all of its prerequisites fulfilled, and execute the most-recent blueprint. Accordingly, if a second version of the software application is later delivered to the consuming system, the software application will automatically detect a newer version of itself, and execute it by analyzing the blueprints.

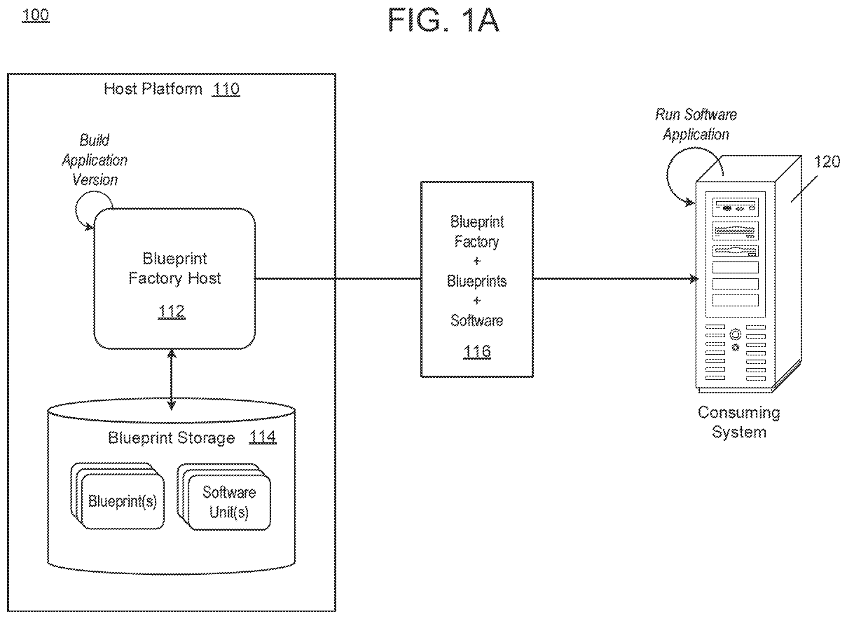

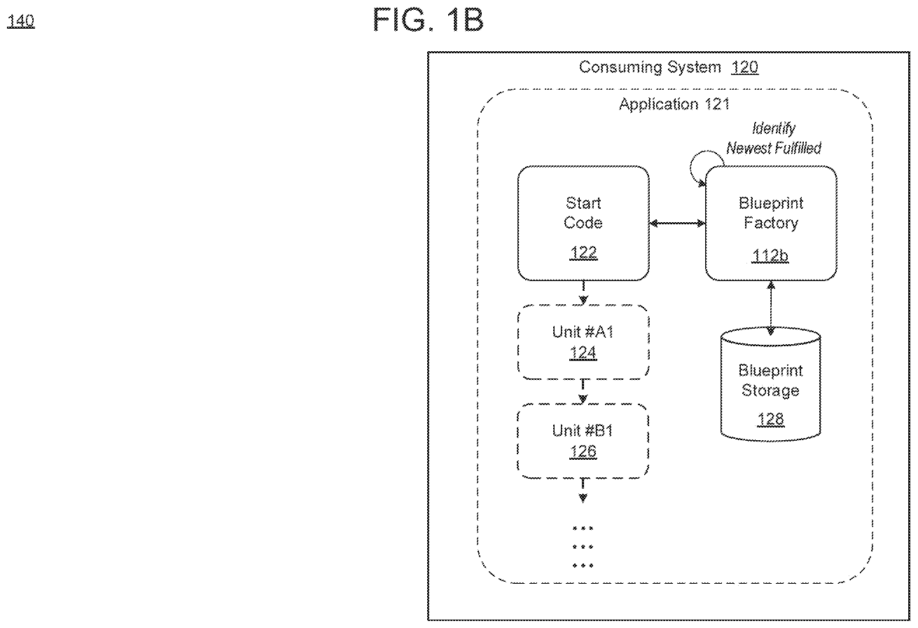

FIGS. 1A-1B illustrate a host platform 110 that delivers a software application in incremental phases in accordance with example embodiments. For example, FIG. 1A illustrates a process 100 of the host platform 110 building a version of a software application by using a blueprint. Referring to FIG. 1A, a host platform 110 hosts a blueprint factory host 112 that is used to develop the software application. Here, the hosts platform 110 may deliver the complete software application including the blueprint factory and blueprints of the software application to a consuming system 120. Here, the consuming system 120 may run the application based on the blueprints that are shipped with the package. For example, the consuming system 120 may deploy the software application (e.g., host it locally, host it on the cloud, etc.).

When the software application is delivered to the consuming system 120, the blueprint factory host 112 and available blueprints for the software application are delivered along with code modules for the identified software application. The blueprints are used from the blueprint factory 112b to check the prerequisites of the different versions of the blueprints at runtime of the software application. The prerequisites and the fulfillment status of the prerequisites may be hardcoded in a particular blueprint themselves and may identify requirements and defines relationships between code modules of the software application for that version. This information is provided during design time on the host platform 110 and is then shipped and available on the consuming system 120 during runtime of the software. As an example, a prerequisite may require that each time code module A is updated (new), a code module B which depends on A must also be updated.

For example, the consuming system 120 run the software application and support customers which connect to the consuming system 120 via a network such as the Internet, and which access the software application via a URL such as a URL of a website, or the like. The initially deployed version of the software application may include all the blueprints that are available for the software application, the blueprint factory, all code modules and a starting software module such as a main program of the software application.

FIG. 1B illustrates a process 140 of starting a software application 121 on the consuming system 120. The package 116 shipped from the host platform 110 to the consuming system 120 and may include the software including all versions of the blueprints for a software application 121, main program 122 of the software application 121, the blueprint factory 112b, and all code modules necessary to run the software application. Here the software application 121 corresponds to the package 116 of FIG. 1A. The main program code 122 may refer to a main code module of the software application 121 that has been shipped to the consuming system 120. Here, the main program 122 may be triggered (e.g., by a user pressing a button on a UI, etc.) causing the main program 122 to request start of the software application.

During application start, the main program 122 may query the blueprint factory 112b which can identify a most-recent blueprint of the software application 121 that has been fulfilled or a fallback blueprint. The returned blueprint from the blueprint factory 112b may build the software application 121 including the code modules 124 and 126. The code modules may be retrieved from the shipped package.

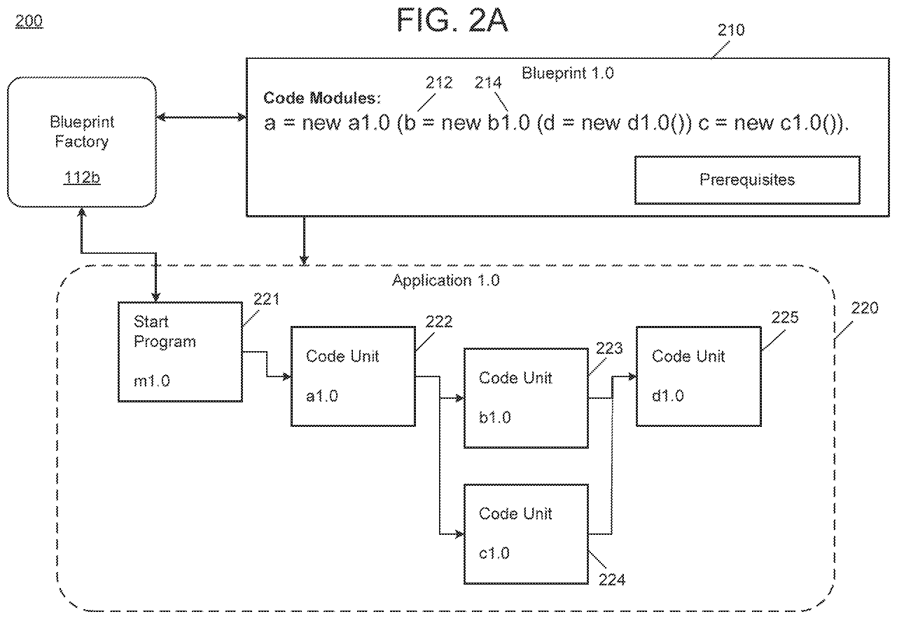

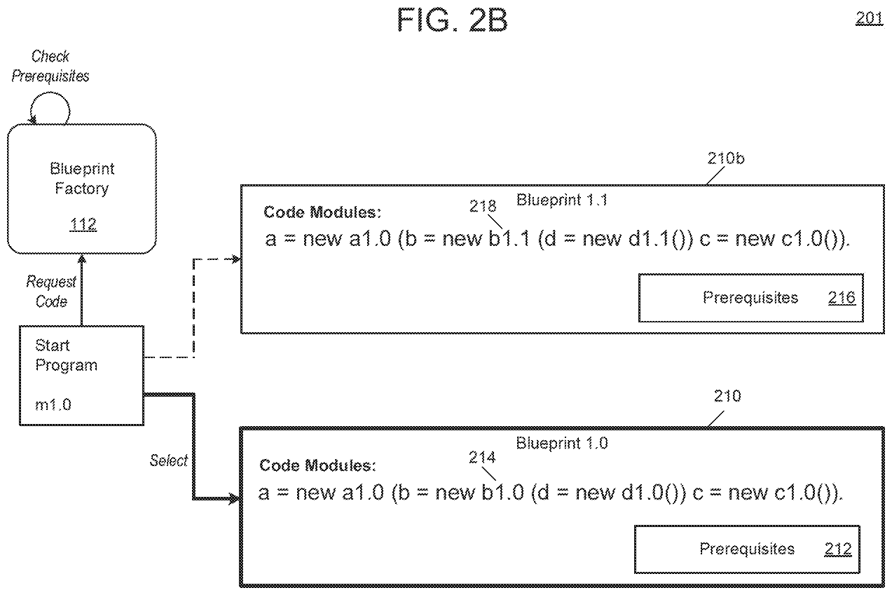

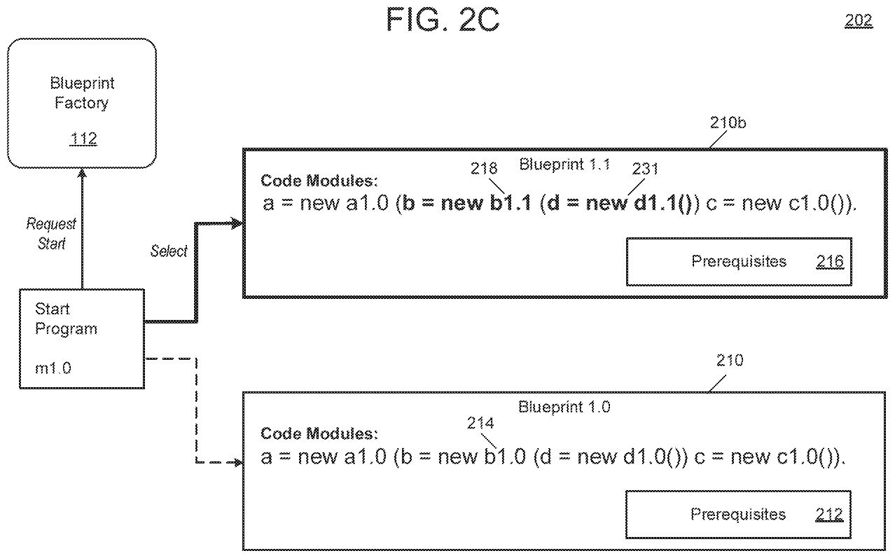

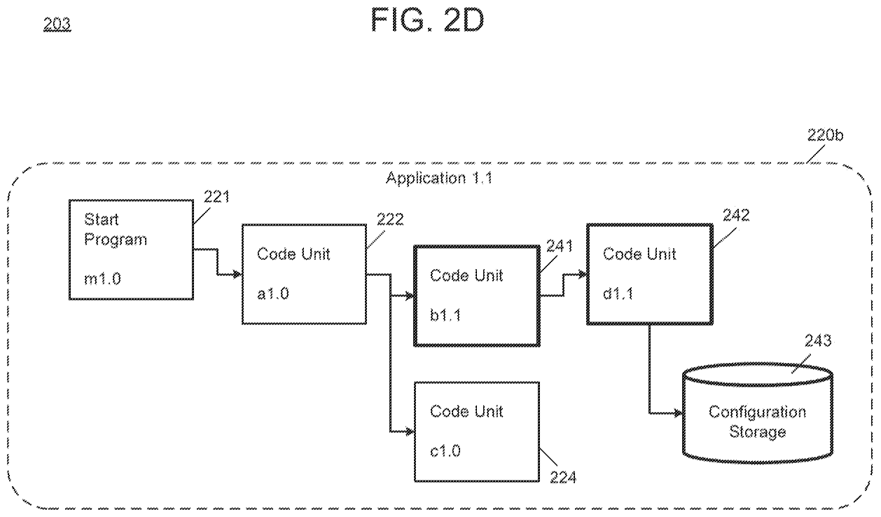

FIG. 2A illustrates an example of a process 200 of executing a software application 220 based on a blueprint 210 in accordance with an example embodiment. Referring to FIG. 2A, a main program 221 of the software application 220 on a consuming system (not shown) may identify a most-recent blueprint that has its prerequisites.

In the example of FIG. 2A, the main program may request the blueprint factory 112b for execution of a software application. In this case, the blueprint factory 112b may identify a blueprint 210 that is the most-recent version of the blueprint for the software application 220. In this example, the blueprint 210 includes prerequisites 212 which are already check to identify the most-recent version furthermore it defines and instantiates the code modules to be used in 214.

For example, the software application 220 may be deployed as shown in FIG. 2A. Here, code units 222, 223, 224, and 225 may be identified by the blueprint 210 and executed by the consuming system after the main program 221. Thus, the software application 220 can be launched based on the blueprint 210.

Over time, a new blueprint 210b for the software application 220 (i.e., a new version of the software application 220) may be added to the blueprint factory 112b by a developer as shown in the example of FIG. 2B. The new blueprint 210b may include new features that have been incrementally added or otherwise improved with respect to a previous blueprint of the software application. However, before the new blueprint 210b is used by the blueprint factory 112b, the blueprint factory 112b may verify that the prerequisites for executing the new blueprint 210b.

For example, FIG. 2B illustrates a process 201 of selecting a fallback blueprint based on unfulfilled prerequisites of the new blueprint 210b in accordance with example embodiments. Referring to FIG. 2B, the new blueprint 210b may include changes, additions, deletions, etc., to the code modules, with respect to the previous blueprint (the blueprint 210 shown in FIG. 2A). For example, the new blueprint 210b may include an updated code module 218 and prerequisites 216 which have also been updated.

In this example, the consuming system 120 may request to start the software application including the main program 221. In response, the blueprint factory 112 on the consuming system 120 may verify the prerequisites 216 that have been updated of the newest/most-recent version of the blueprint of the software application which is the new blueprint 210b. In this example, a prerequisite requires e.g. a certain configuration or a activated feature toggle in the system and it's not fulfilled. In this case, the blueprint factory 112b detects the missing prerequisite, selects a fall back blueprint (previous valid version), and executes the software application on the consuming system 120 based on the fallback blueprint.

In FIG. 2C, an user such as a system administrator fulfilled the prerequisites 216 e.g. by adding the missing configuration and activation of the missing feature toggle. has registered a newly-developed code component 232 (code unit d.1.1). The newly-developed code component 232 may be added to the new blueprint 210b (stored therein) or otherwise registered with the blueprint factory 112b on the consuming system 120 thereby providing notice to the blueprint factory 112b of the existence of the newly-developed code component 232.

Accordingly, the next time that the main program requests execution of the software application, the blueprint factory 112 on the consuming system 120 may select the new blueprint 210b instead of the previous blueprint (e.g., the blueprint 210) and execute the software application based on the version of the new blueprint 210b. For example, as shown in FIG. 2C, the blueprint factory 112b may determine that a previously missing perquisite 216 has been fulfilled due to the activity of the system administrator, therefore the new blueprint 210b is ready to be used. In this case, the blueprint factory 112b may use the code modules, etc., within the new blueprint 210b (most-recent) to launch the software application on the consuming system 120.

FIG. 2D illustrates a process 203 of executing the software application based on the new blueprint 210b in accordance with an example embodiment. Referring to FIG. 2D, the newest version of the blueprint (blueprint 210b) is determined to fulfill each of its prerequisites and is used as a model for running the software application (software application 220b) which includes a modified code structure as a result of the new blueprint 210b, in comparison to the software application 220 based on the blueprint 210.

In this example, the software application 220b is connected to an additional storage 243 via modified code units 241 and 242 based on the new blueprint 210b. In this way, incremental changes can be developed without an day one impact to the end user and without breaking the system due to a new installed version without fulfilled prerequisites. Instead, blueprints of the software application can be used to decide which code modules are executed by a consuming system. The blueprints are based off of the versions of the software developed by the consumers (or by other consumers).

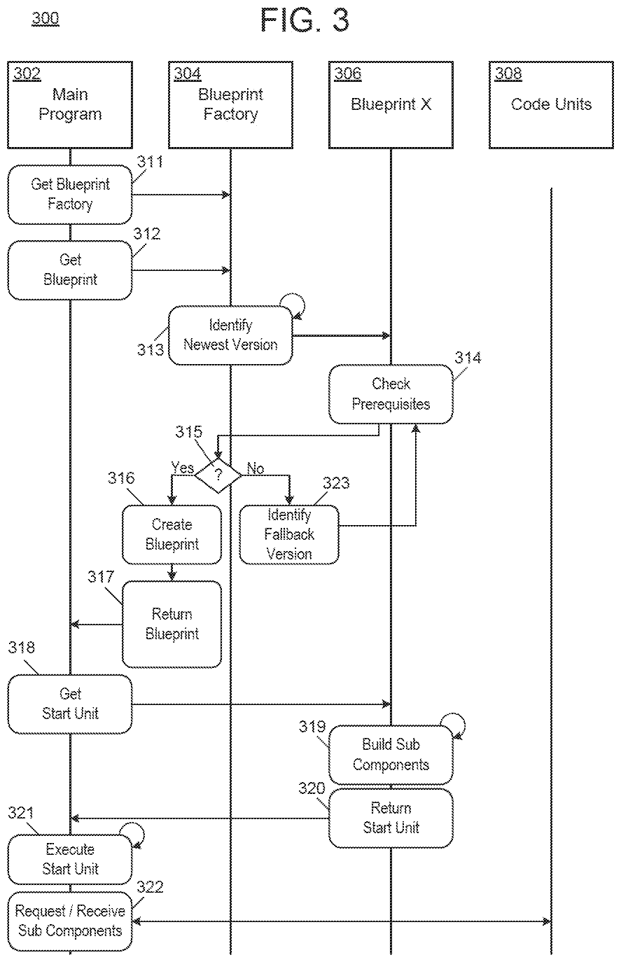

FIG. 3 illustrates a communication sequence that is performed on a consuming system for executing a software application based on blueprints in accordance with example embodiments. The example shown in FIG. 3occurs after the software application and the blueprints have been shipped to the consuming system (e.g., consuming system 120 shown in FIG. 1A). Therefore, the interactions that occur in FIG. 3 may take place on the consuming system. For example, the communication sequences in FIG. 3 may be carried out between a blueprint factory running on the consuming system and a main program of a software application which is also running on the consuming system. In some cases, the consuming system may also be installed on the host platform, such as another software application hosted on the cloud platform, but embodiments are not limited thereto. As another example, the consuming system may be a network-connected device such as a web server, an on-premises server, a cloud platform, a user device, etc.

In particular, FIG. 3 illustrates a process 300 of relying on a fallback blueprint of a software application based on an execution request from a main program 320 of the software application running on a consuming system (not shown). For example, in 311, the main program may receive a instance of a blueprint factory 304.

An application may be started after receiving the blueprint factory. For example, in 312, the application may start based on a user input and, in 313, the blueprint factory 304 may identify a most-recent version/blueprint of the software application, and query the blueprint 306 to check whether the prerequisites have been fulfilled, in 314. For example, the blueprint factory 304 of the consuming system may query the blueprint 306 itself to identify the prerequisites and then to verify if the prerequisites are contained in the blueprint or otherwise registered with the blueprint factory 304.

In 315, the blueprint factory 304 determines whether or not the prerequisites for the most-recent version/blueprint of the software application has been fulfilled. The blueprint factory 304 determines the prerequisites have been fulfilled 315, if not, in 323 the blueprint factory 304 may identifies a fallback blueprint/version of the software application. Again, the prerequisites are checked in 314 and decided in 315 if the blueprint can be used. In 317, the blueprint factory 304 may return the selected blueprint to the main program 302.

In 318, the main program 302 requests a start unit from the fallback blueprint from among the repository of blueprints 306. In this case, the fallback blueprint includes the code modules for executing the most recent/valid version of the software application prior to the new blueprint being submitted. In 319, the blueprint factory 304 may compose the software application based on the blueprint including a start module and any dependent modules, and transfer them to the main program 302, in 320. In 321, the main program 302 may request and receive the code from a set of code units 308 held by the blueprint factory 304. Furthermore, in 322, the main program 302 may execute the start unit, and execute the remaining sub-components.

Returning again now to step 315, if in 315 the blueprint factory 304 determines that the perquisites of the blueprint have not been fulfilled, in 323, the blueprint factory 304 may identify a fallback blueprint, for example, a next most-recent blueprint of the software application and perform the check for prerequisites over again. Here, the process may return to step 314 and continue to loop between steps 314, 315, and 323, until a blueprint is found that has satisfied all prerequisites. If blueprint is not found, the process may terminate or throw an error.

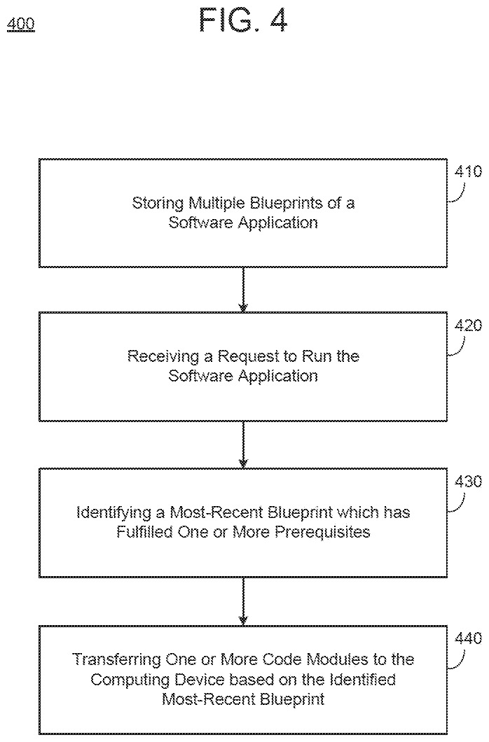

FIG. 4 illustrates a method 400 of executing a software application based on a blueprint in accordance with an example embodiment. For example, the method 400 may be performed by a software application hosted by a host platform such as a cloud platform, a web server, a distributed system, a database, or the like. Referring to FIG. 4, in 410, the method may include storing multiple blueprints of a software application, wherein each blueprint comprises different code dependencies between code modules of the software application. The blueprints may be uploaded to the host system may users of the system such as developers and the like. The blueprints may be registered with a blueprint factory (e.g., a software application). The blueprint factory may keep a mapping that identifies which blueprint corresponds to which version of a software application.

In 420, the method may include receiving a request to run the software application from a computing device. For example, the request may include a call such as an API call or the like which is sent to an API of the blueprint factory. The call may include an identifier of a software application. In response, in 430, the method may include identifying a most-recent blueprint of the software application, from among the multiple blueprints, which has fulfilled one or more prerequisites. The prerequisites may be defined using code inside the blueprints. An example of checking the prerequisites is shown and described in FIGS. 2A-2D herein.

In 440, the method may include transferring one or more code modules of the software application to the computing device based on dependencies between the one or more code modules included in the identified most-recent version of the blueprint. Here, the blueprint factory has identified a blueprint of the software application that has fulfilled all of its prerequisites. The prerequisites may require updates to code units, updates to storage devices, updates in the ordering of the code modules, new code modules, removal of code modules, and the like. The prerequisites may be stored in the blueprint itself and queried/read from the blueprint by the blueprint factory.

In some embodiments, the receiving may include receiving the request to run the software application from a main code module of the software application which is previously shipped to the computing device. In some embodiments, the identifying may include identifying a newest version of the blueprint in a blueprint data store and determining that the newest version of the blueprint has not fulfilled the one or more prerequisites based on the newest version of the blueprint. In response to the determination, in some embodiments, the identifying may further include identifying a next newest version of the blueprint in the blueprint data store, determining that the next newest version of the blueprint has fulfilled the one or more prerequisites, and in response, transferring code modules included in the next most-recent version of the blueprint.

In some embodiments, the downloading may include generating an instance of the software application based on the dependencies between the one or more code modules included in the most-recent version of the blueprint, and downloading the instance of the software application to the computing device. In some embodiments, the method may further include downloading a prior version of the software application to the computing device, prior to downloading the one or more code modules of the software application to the computing device.

In some embodiments, the identifying may further include identifying a new code module that is included in the most-recent version of the software application that is not included in the prior version of the software application, and identifying a prerequisite of the most-recent version of the software application that is not a prerequisite for the prior version of the software application. In some embodiments, the identifying may further include verifying that the identified prerequisite of the most-recent version of the blueprint has been fulfilled based on a query of the most-recent version of the blueprint.

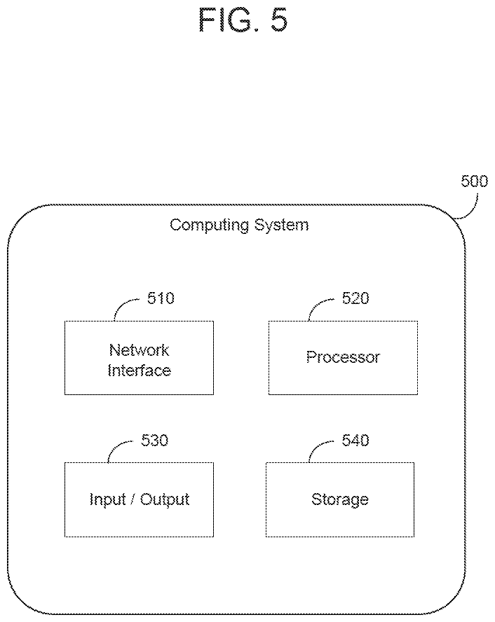

FIG. 5 illustrates a computing system 500 that may be used in any of the methods and processes described herein, in accordance with an example embodiment. For example, the computing system 500 may be a database node, a server, a cloud platform, or the like. In some embodiments, the computing system 500 may be distributed across multiple computing devices such as multiple database nodes. Referring to FIG. 5, the computing system 500 includes a network interface 510, a processor 520, an input/output 530, and a storage 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control the other components of the computing system 500.

The network interface 510 may transmit and receive data over a network such as the Internet, a private network, a public network, an enterprise network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage 540, or a combination thereof, may interact with applications executing on other devices.

The storage 540 is not limited to a particular storage device and may include any known memory device such as RAM, ROM, hard disk, and the like, and may or may not be included within a database system, a cloud environment, a web server, or the like. The storage 540 may store software modules or other instructions which can be executed by the processor 520 to perform the methods described herein. According to various embodiments, the storage 540 may include a data store having a plurality of tables, records, partitions and sub-partitions. The storage 540 may be used to store database records, documents, entries, and the like.

According to various embodiments, the storage 540 may store multiple versions of a blueprint of a software application. Here, each blueprint may be a file or other computer-readable medium with hardcoded instructions stored therein which identify code modules that are needed for a version of the software application and dependencies among the code modules when they are executed. Each different version of a blueprint may include different code dependencies between code modules of the software application. It may also include different code modules, different ordering, and the like.

According to various embodiments, the processor 520 may receive a request to run the software application from a computing device. In response, the processor 520 may identify one or more prerequisites for the blueprint to be active. For example, by querying the blueprint. The processor 520 may determine a most-recent version of the blueprint from among the multiple versions of the blueprint which has fulfilled the one or more prerequisites. Further, the processor 520 may transfer one or more code modules of the software application to the computing device based on dependencies between the one or more code modules included in the most-recent version of the blueprint.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory medium.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. An apparatus comprising:
a storage configured to store multiple versions of a blueprint of a software application, wherein each version of the blueprint comprises different code dependencies between code modules of the software application; and
a processor configured to
receive a request to run the software application from a computing device,
identify one or more prerequisites for the blueprint to be active,
determine a most-recent version of the blueprint from among the multiple versions of the blueprint which has fulfilled the one or more prerequisites, and
transfer one or more code modules of the software application to the computing device based on dependencies between the one or more code modules included in the most-recent version of the blueprint.

2. The apparatus of claim 1, wherein the processor is configured to receive the request to run the software application from a main code module of the software application which is previously shipped to the computing device.

3. The apparatus of claim 1, wherein the processor is configured to identify a most-recent version of the blueprint in a blueprint data store, and determine that the most-recent version of the blueprint has not fulfilled the one or more prerequisites based on the most-recent version of the blueprint.

4. The apparatus of claim 3, wherein the processor is further configured to identify a next most-recent version of the blueprint in response to the determination that the most-recent version of the blueprint has not fulfilled the one or more prerequisites, determine that the next most-recent version of the blueprint has fulfilled the one or more prerequisites, and in response, execute code modules included in the next most-recent version of the blueprint.

5. The apparatus of claim 1, wherein the processor is further configured to generate an instance of the software application based on the dependencies between the one or more code modules included in the most-recent version of the blueprint, and execute the instance of the software application on the computing device.

6. The apparatus of claim 1, wherein the processor is further configured to download a prior version of the software application to the computing device, prior to downloading the one or more code modules included in the most-recent version of the blueprint.

7. The apparatus of claim 6, wherein the processor is further configured to identify a new code module that is included in the most-recent version of the blueprint that is not included in the prior version of the software application based on the one or more code modules included in the most-recent version of the blueprint, and identify a prerequisite of the new code module that is not a prerequisite for the prior version of the software application.

8. The apparatus of claim 7, wherein the processor is configured to verify that the identified prerequisite of the new code module has been fulfilled based on a query of the most-recent version of the blueprint.

9. A method comprising:
storing multiple blueprints of a software application, wherein each blueprint comprises different code dependencies between code modules of the software application;
receiving a request to run the software application from a computing device;
identifying a most-recent blueprint, from among the multiple blueprints, which has fulfilled one or more prerequisites; and
executing one or more code modules of the software application at the computing device based on dependencies between the one or more code modules included in the identified most-recent blueprint.

10. The method of claim 9, wherein the receiving comprises receiving the request to run the software application from a main code module of the software application which is previously shipped to the computing device.

11. The method of claim 9, wherein the identifying comprises identifying a newest version of the blueprint in a blueprint data store and determining that the newest version of the blueprint has not fulfilled the one or more prerequisites based on the newest version of the blueprint.

12. The method of claim 11, wherein, in response to the determination, the identifying further comprises identifying a next newest version of the blueprint in the blueprint data store, determining that the next newest version of the blueprint has fulfilled the one or more prerequisites, and in response, executing code modules included in the next newest version of the blueprint.

13. The method of claim 9, wherein the executing comprises generating an instance of the software application based on the dependencies between the one or more code modules included in the most-recent blueprint, and executing the instance of the software application at the computing device.

14. The method of claim 9, wherein the method further comprises downloading code modules from a prior version of the software application to the computing device, prior to downloading the one or more code modules included in the most-recent blueprint.

15. The method of claim 14, wherein the identifying further comprises identifying a new code module that is included in the most-recent blueprint that is not included in the prior version of the software application based on the one or more code modules included in the most-recent blueprint, and identifying a prerequisite of the new code module that is not a prerequisite for the prior version of the software application.

16. The method of claim 15, wherein the identifying further comprises verifying that the identified prerequisite of the new code module has been fulfilled based on a query of the most-recent blueprint.

17. A computer-readable medium comprising instructions which when executed by a processor cause a computer to perform a method comprising:
storing a blueprint of a software application, wherein the blueprint comprises code dependencies between code modules of the software application;
receiving a request to run the software application from a computing device;
determining that one or more prerequisites of the blueprint have not been fulfilled based on querying the blueprint in a blueprint data store;
identifying a fallback blueprint of the software application which contains prerequisites that have all been fulfilled based on querying the fallback blueprint; and
executing one or more code modules of the software application at the computing device based on dependencies between the one or more code modules included in the fallback blueprint.

18. The computer-readable medium of claim 17, wherein the receiving comprises receiving the request to run the software application from a main code module of the software application which is previously shipped to the computing device.

19. The computer-readable medium of claim 17, wherein the identifying comprises identifying a newest version of the blueprint in a blueprint data store and determining that the newest version of the blueprint has not fulfilled the one or more prerequisites based on the newest version of the blueprint.

20. The computer-readable medium of claim 17, wherein the identifying the fallback blueprint comprises identifying a next newest blueprint of the software application in the blueprint data store.
